(19) United States
(12) Patent Application Publication
(10) Pub. No.: US 2026/0169418 A1
(43) Pub. Date: Jun. 18, 2026

(54) IMAGE FORMING APPARATUS

(71) Applicant: KYOCERA Document Solutions Inc., Osaka (JP)

(72) Inventors: Kaori KATSUMOTO, Osaka (JP); Yuya SHIMOHORA, Osaka (JP)

(73) Assignee: KYOCERA Document Solutions Inc., Osaka (JP)

(21) Appl. No.: 19/407,625

(22) Filed: Dec. 3, 2025

(30) Foreign Application Priority Data
Dec. 16, 2024 (JP) 2024-220045

(51) Int. Cl. G03G 15/00; G03G 21/00

(52) U.S. Cl. CPC G03G 15/6564; G03G 15/6567; G03G 21/00; G03G 2221/0042; G03G 2221/0089

(57) ABSTRACT

One of a holding portion and a grip portion includes an inner tube portion that is tubular and extends from an end part thereof in an axial direction toward the other of the holding portion and the grip portion to be located within the outer tube portion. The holding portion is connected to the grip portion, via an elastic member disposed within the inner tube portion, so as to be vibratable in the axial direction. The outer tube portion includes an opening that penetrates the outer tube portion in a radial direction thereof. The inner tube portion includes a protrusion that protrudes from an outer surface of the inner tube portion so as to be located within the opening. When the holding portion vibrates, the protrusion moves in the axial direction within the opening.

### INCORPORATION BY REFERENCE

This application is based on and claims the benefit of priority from Japanese Patent Application No. 2024-220045 filed on Dec. 16, 2024, the contents of which are hereby incorporated by reference.

### BACKGROUND

The present disclosure relates to an image forming apparatus including a roller pair that conveys a sheet and a paper powder collection member that collects paper powder adhered to the roller pair.

A conventional image forming apparatus includes a roller pair and a paper powder collection member. The roller pair is disposed in the main body of the image forming apparatus, and conveys a sheet by nipping it. The paper powder collection member is movable for insertion and removal along the axial direction of the roller pair, and is disposed in contact with one of the rollers constituting the roller pair to thereby collect paper powder adhered to the roller pair.

However, with this configuration, in a case where the roller pair has slid in the axial direction, the contact position of the paper powder collection member and the roller may be shifted, resulting in a decline of paper powder collection efficiency.

An object of the present disclosure is to provide an image forming apparatus capable of suppressing the decline of paper powder collection efficiency.

### SUMMARY

To achieve the above object, according to a first configuration of the present disclosure, an image forming apparatus includes a roller pair and a paper powder collection member. The roller pair is disposed in a main body of the image forming apparatus and conveys a sheet by nipping the sheet. The paper powder collection member is movable for insertion and removal along an axial direction of the roller pair, and disposed in contact with one of rollers constituting the roller pair to thereby collect paper powder adhered to the roller pair. The paper powder collection member includes a contact member and a holding member. The contact member contacts the roller pair to thereby collect paper powder. The holding member holds the contact member. The holding member includes a holding portion and a grip portion. The holding portion extends in the axial direction to hold the contact member. The grip portion is disposed on one side of the holding portion in the axial direction. One of the holding portion and the grip portion includes an outer tube portion that is tubular and extends from an end part thereof in the axial direction toward the other of the holding portion and the grip portion. The other of the holding portion and the grip portion includes an inner tube portion that is tubular and extends from an end part thereof in the axial direction toward the one of the holding portion and the grip portion so as to be located within the outer tube portion. The holding portion is connected to the grip portion via an elastic member disposed within the inner tube portion so as to be vibratable in the axial direction. The outer tube portion includes an opening that penetrates the outer tube portion in a radial direction thereof. The inner tube portion includes a protrusion that protrudes from an outer surface of the inner tube portion so as to be located within the opening. When the holding portion vibrates, the protrusion moves in the axial direction within the opening.

This and other objects of the present disclosure, and the specific benefits obtained according to the present disclosure, will become apparent from the description of embodiments which follows.

### BRIEF DESCRIPTION OF THE DRAWINGS

FIG. 1 is a sectional view schematically showing a structure of an image forming apparatus according to one embodiment of the present disclosure.

FIG. 2 is a sectional view of a registration roller pair and a paper powder collection member of the image forming apparatus according to one embodiment of the present disclosure as seen from an axial direction.
FIG. 3 is a perspective view of the paper powder collection member of the image forming apparatus according to one embodiment of the present disclosure.
FIG. 4 is a sectional perspective view showing, in an enlarged manner, part of the paper powder collection member of the image forming apparatus according to one embodiment of the present disclosure.

### DETAILED DESCRIPTION

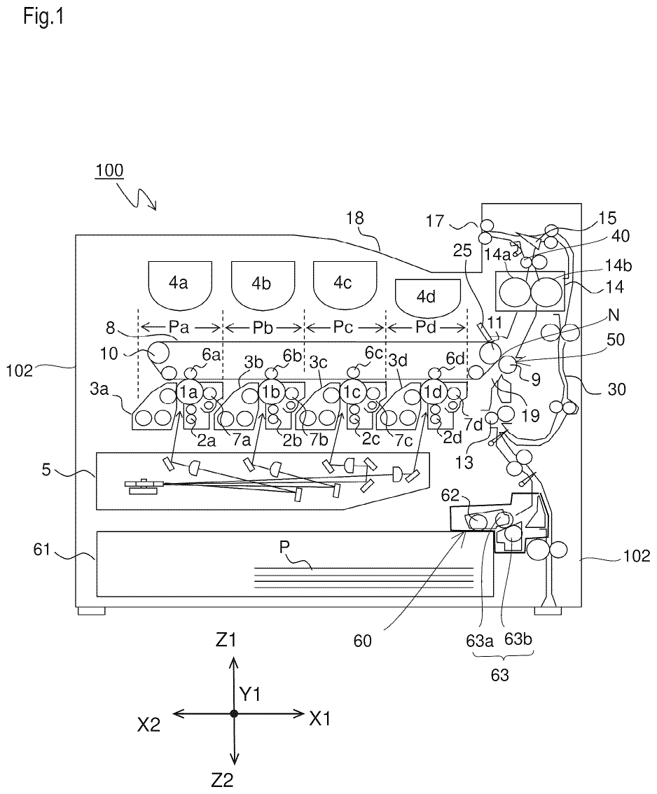

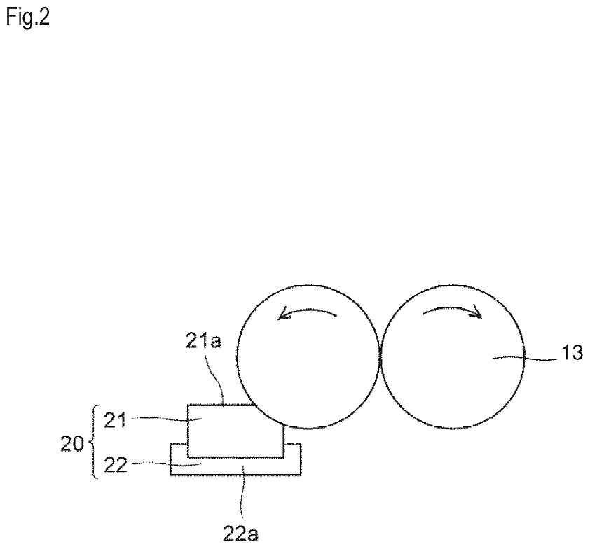

Hereinafter, embodiments of the present disclosure will be described with reference to the accompanying drawings. FIG. 1 is a sectional view schematically showing a structure of an image forming apparatus 100 according to a first embodiment of the present disclosure. For convenience of description, a vertical direction in a state where the image forming apparatus 100 is usably installed (the state shown in FIG. 1) is defined as an up-down direction (Z1-Z2). Regarding a face of the image forming apparatus 100, the face being located on the side forward of the plane on which FIG. 1 is depicted, as the front face (i.e., the front) of the image forming apparatus 100, a front-rear direction (Y1-Y2) is defined. With reference to the front face of the image forming apparatus 100 in the installed state, a left-right direction (X1-X2) is defined. In the present embodiment, the left-right direction (X1-X2) is orthogonal to both the up-down direction (Z1-Z2) and the front-rear direction (Y1-Y2). The left-right direction (X1-X2) is a facing direction in which a pair of side faces of the image forming apparatus 100 face each other, and the front-rear direction (Y1-Y2) is an axial direction of the registration roller pair 13. It should be noted that the definition of the up-down direction does not in any way limit the orientation or positional relationship of the image forming apparatus 100 during use.

The image forming apparatus 100 includes image forming portions Pa to Pd, a sheet feed unit 60, a transfer portion 50, a fixing portion 14, a discharge portion 17, a conveyance roller pair 40, a sheet conveyance path 19, and a branch conveyance path 30.

Within a main body of the image forming apparatus 100 (herein, a color printer) the four image forming portions Pa, Pb, Pc, and Pd are arranged sequentially from the upstream side in a conveyance direction (left side in FIG. 1). The image forming portions Pa to Pd form images on a sheet (recording medium) P.

More specifically, the image forming portions Pa to Pd are provided respectively corresponding to images of four different colors (i.e., yellow, cyan, magenta and black). The image forming portions Pa to Pd sequentially form images of yellow, cyan, magenta, and black, respectively, through processes of charging, exposure, development, and transfer.

The image forming portions Pa to Pd respectively form visible images (toner images) of their corresponding colors on photosensitive drums (image carriers) 1a to 1d. Further, an intermediate transfer belt (an intermediate transfer body) 8 is provide adjacent to the image forming portions Pa to Pd. The toner images formed on the photosensitive drums 1a to 1d are primarily transferred sequentially onto the intermediate transfer belt 8, which moves in contact with the photosensitive drums 1a to 1d, such that the toner images are superimposed one on top of another.

The transfer portion 50 transfers the toner images formed at the image forming portions Pa to Pd onto a sheet P (a recording medium). The transfer portion 50 includes a drive roller 11 and a secondary transfer roller 9. Specifically, the toner images having been primarily transferred onto the intermediate transfer belt 8 are secondarily transferred by the secondary transfer roller 9 onto the sheet P, which is an example of the recording medium. The sheet P having the toner images secondarily transferred thereto is subjected to fixing of the toner images at the fixing portion 14, and is then discharged from the main body of the image forming apparatus 100.

The sheet feed unit 60 feeds a sheet P to the image forming portions Pa to Pd. Specifically, the sheet feed unit 60 includes a pickup roller 62, a feed roller 63a, and a retard roller 63b. The sheet feed unit 60 is disposed on an upper side Z1 of a sheet cassette 61. The sheet cassette 61 is disposed at a lower part in the main body of the image forming apparatus 100, and stores sheets P onto which toner images are to be secondarily transferred.

The pickup roller 62 is pressed against an upper surface of a sheet P with a predetermined pressure. The pickup roller 62 is caused to rotate to thereby start feeding of the sheet P. That is, the pickup roller 62 makes contact with a sheet (recording medium) P stored in the sheet cassette 61, and sends out the sheet (recording medium) P into the sheet conveyance path 19.

The feed roller 63a and the retard roller 63b constitute a sheet feed roller pair 63. The feed roller 63a conveys a sheet (recording medium) P having been sent out by the pickup roller 62. The retard roller 63b is pressed against the feed roller 63a to form a nip portion, and conveys sheets P while separating them one from another.

Used as the intermediate transfer belt 8 is a dielectric resin sheet, typically in the form of a belt with no seam (a seamless belt). Further, at a position downstream of the secondary transfer roller 9, a belt cleaner 25, which is blade-shaped, is disposed for removing toner and the like remaining on the surface of the intermediate transfer belt 8.

Around or below the photosensitive drums 1a to 1d, which are rotatably arranged, there are provided charging devices 2a, 2b, 2c, and 2d, an exposure device 5, developing devices 3a, 3b, 3c, and 3d, and cleaning devices 7a, 7b, 7c, and 7d. The charging devices 2a, 2b, 2c, and 2d charge the photosensitive drums 1a to 1d. The exposure device 5 exposes the photosensitive drums 1a to 1d to light based on image data. The developing devices 3a, 3b, 3c, and 3d form toner images on the photosensitive drums 1a to 1d. The cleaning devices 7a, 7b, 7c, and 7d remove developer (toner) and the like remaining on the photosensitive drums 1a to 1d.

When image data is fed from a host device such as a personal computer, first, the charging devices 2a to 2d uniformly charge surfaces of the photosensitive drums 1a to 1d. Subsequently, the exposure device 5 executes light irradiation based on the image data, thereby forming electrostatic latent images on the photosensitive drums 1a to 1d based on the image data. The developing devices 3a to 3d are each loaded with a predetermined amount of two-component developer including a yellow, cyan, magenta, or black toner. When the ratio of toner in the two-component developer loaded in each of the developing devices 3a to 3d falls below a reference value, the toner is supplied to each of the developing devices 3a to 3d from a corresponding one of toner containers 4a to 4d.

The toner included in the developer is supplied by each of the developing devices 3a to 3d, and electrostatically adhere, to a corresponding one of the photosensitive drums 1a to 1d. In this manner, toner images are formed corresponding to the electrostatic latent images having been formed through the exposure to light by the exposure device 5.

Then, primary transfer rollers 6a to 6d impart an electric field at a predetermined transfer voltage between the primary transfer rollers 6a to 6d and the photosensitive drums 1a to 1d, and thereby, the yellow, cyan, magenta, and black toner images on the photosensitive drums 1a to 1d are primarily transferred onto the intermediate transfer belt 8. These images are formed with a predetermined positional relationship. Thereafter, in preparation for the subsequently performed formation of new electrostatic latent images, toner and the like remaining on the surfaces of the photosensitive drums 1a to 1d after the primary transfer are removed by the cleaning devices 7a to 7d.

The intermediate transfer belt 8 is stretched around a driven roller 10 on an upstream side thereof and the drive roller 11 on a downstream side thereof. When the intermediate transfer belt 8 starts to rotate counterclockwise in accordance with the rotation of the drive roller 11 caused by a belt drive motor (unillustrated), a sheet P is conveyed from the registration roller pair 13, with predetermined timing, to a secondary transfer nip portion N formed between the drive roller 11 and the secondary transfer roller 9 provided adjacent to the drive roller 11. Then, the toner images on the intermediate transfer belt 8 are secondarily transferred onto the sheet P passing through the secondary transfer nip portion N.

After having the toner images secondarily transferred thereto, the sheet P is conveyed to the fixing portion 14. The fixing portion 14 includes a fixing belt 14a and a pressure roller 14b.

The fixing belt 14a is heated by a heating device (unillustrated) such as a heater, an induction heating unit, etc. The pressure roller 14b is pressed against the fixing belt 14a to form a fixing nip, and imparts a rotational driving force to the fixing belt 14a.

The sheet P having been conveyed to the fixing portion 14 is heated and pressed by the fixing belt 14a and the pressure roller 14b, and thereby the toner images are fixed to the surface of the sheet P, forming a predetermined full-color image.

The sheet P having the full-color image formed thereon passes through the conveyance roller pair 40 to be then guided by a conveyance guide member 15, which is disposed at the branching portion of the sheet conveyance path 19, into one of conveyance directions, and is then discharged as it is (or after being diverted to the branch conveyance path 30 to have images formed on both sides) onto a discharge tray 18 by a discharge roller pair (discharge portion) 17.

The conveyance roller pair 40 sends a sheet (recording medium) P from the fixing portion 14 to the discharge roller pair (discharge portion) 17.

The sheet conveyance path 19 connects the sheet feed unit 60, the transfer portion 50, the fixing portion 14, and the discharge portion 17. The branch conveyance path 30 branches off from the sheet conveyance path 19 at a position on a downstream side of the conveyance roller pair 40, and rejoins the sheet conveyance path 19 at a position on an upstream side of the registration roller pair 13. The branch conveyance path 30 extends in the up-down direction (Z1-Z2) along a side face 102 of the image forming apparatus 100, and curves substantially in a C-shape.

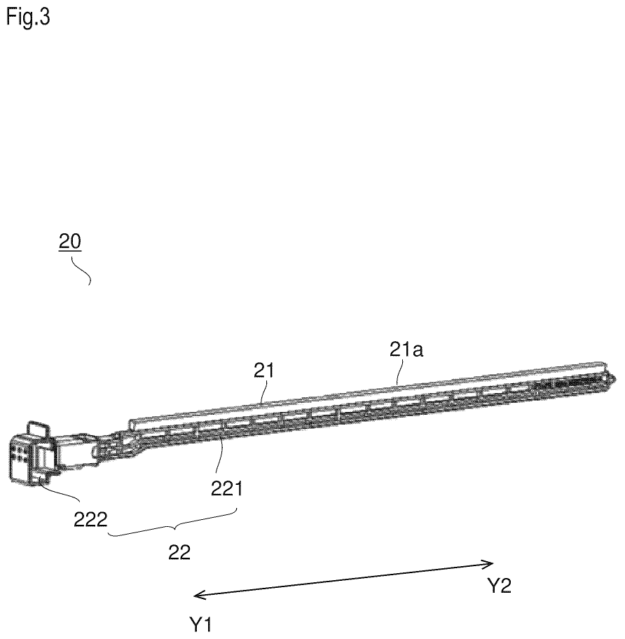

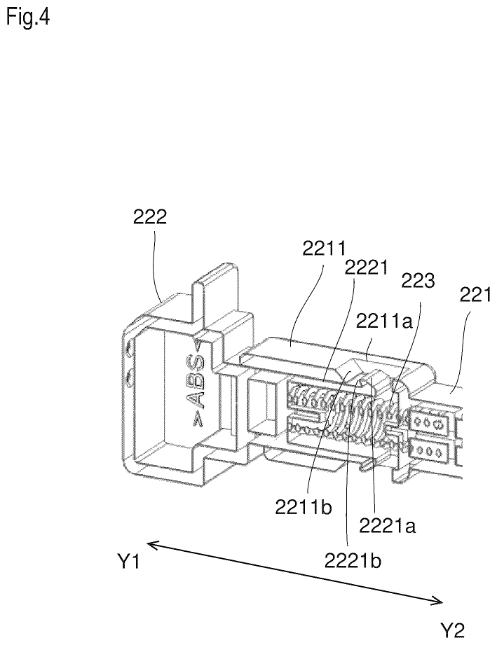

FIG. 2 is a sectional view of the registration roller pair 13 and the paper powder collection member 20 as seen from the axial direction, and FIG. 3 is a perspective view of the paper powder collection member 20. FIG. 4 is a sectional perspective view showing part of the paper powder collection member 20 in an enlarged manner. The registration roller pair 13 is constituted of a metal roller that is made of iron, for example, and that functions as a drive roller and a rubber roller that functions as a driven roller, and these two rollers are disposed parallel to each other to be pressed against each other, thereby forming a nip portion. The registration roller pair 13 corrects skew of a sheet P by having an edge of the sheet P contact the nip portion. Further, the registration roller pair 13 is caused by an unillustrated drive motor to rotate to thereby convey the sheet P to the secondary transfer nip portion P in coordination with the timing of image formation.

In the vicinity of the registration roller pair 13, the paper powder collection member 20 is disposed. The paper powder collection member 20 extends along the registration roller pair 13 in the axial direction, and is movable on an unillustrated rail for insertion and removal along the axial direction of the registration roller pair 13 (referred to simply as the axial direction below). Further, the paper powder collection member 20 is disposed in contact with the circumferential surface of one of the rollers constituting the registration roller pair 13, and thereby collects paper powder adhered on the registration roller pair 13.

The paper powder collection member 20 includes a contact member 21 and a holding member 22. The contact member 21 contacts one of the rollers constituting the registration roller pair 13 (the metal roller, the left-side roller in FIG. 2, for example) to collect paper powder, and the contact member 21 is formed of sponge, for example.

The holding member 22 holds the contact member 21 and is formed of resin. The contact member 21 is formed in a rectangular parallelepiped shape extending in the axial direction, and is fixed to the holding member 22 by bonding. Further, an upper surface 21a of the contact member 21 is a collection surface that contacts the registration roller pair 13 to collect paper powder.

The holding member 22 includes a holding portion 221 and a grip portion 222. The holding portion 221 extends in the axial direction and holds the contact member 21. The grip portion 222 is disposed on a removal direction (one axial direction) Y1 side of the holding portion 221 and is held by hand to move the paper powder collection member 20 for insertion and removal.

The holding portion 221 includes an outer tube portion 2211, which is tubular.

The outer tube portion 2211 extends in the removal direction Y1 from an end part of the holding portion 221 in the removal direction (axial direction) Y1.

In the present embodiment, the holding portion 221 and the outer tube portion 2211 are integrally formed of resin.

The outer tube portion 2211 includes an opening 2211a that penetrates it in the radial direction and extends in the axial direction.

The grip portion 222 includes an inner tube portion 2221. The inner tube portion 2221 extends in the insertion direction (axial direction) Y2 from an end part of the grip portion 222 in the insertion direction (axial direction) Y2. In the present embodiment, the grip portion 222 and the inner tube portion 2221 are integrally formed of resin. The inner tube portion 2221 has a protrusion 2221a that protrudes from an outer surface thereof so as to be located within the opening 2211a.

The protrusion 2221a includes a plurality of protrusions 2221a disposed at two positions, one in an upper part and the other in a lower part of the inner tube portion 2221. The opening 2211a includes a plurality of openings 2211a disposed at two positions, one in an upper part and the other in a lower part of the outer tube portion 2211, corresponding to the protrusions 2221a. That is, the plurality of protrusions 2221a are arranged circumferentially on the outer circumferential surface of the inner tube portion 2221, with the plurality of openings 2211a positioned corresponding to the protrusions 2221a.

In an inside of the inner tube portion 2221, a coil spring (elastic member) 223 is disposed. In the present embodiment, an end part of the coil spring 223 in the insertion direction (the other axial direction) Y2 is secured to a bottom part of the outer tube portion 2211. Thereby, the holding portion 221 is connected to the grip portion 222 via the coil spring (elastic member) 223 so as to be vibratable in the axial direction (Y1-Y2). With this arrangement, when one of the rollers constituting the registration roller pair 13 that is in contact with the paper powder collection member 20 shifts in the axial direction (Ys-Y2), the contact member 21 also shifts in the axial direction following the roller. Thus, it is possible to suppress decline in the efficiency of collecting paper powder.

When the holding portion 221 vibrates, the protrusion 2221a moves in the axial direction within the opening 2211a. In this manner, the protrusion 2221a is guided within the opening 2211a, allowing the holding portion 221 to vibrate smoothly in the axial direction. At this time, since the protrusion 2221a and the opening 2211a are each provided in plurality, the holding portion 221 moves more smoothly in the axial direction.

The vibration width of the holding portion 221 in the axial direction is restricted by the width of the opening 2211a in the axial direction. When the holding portion 221 vibrates largely with respect to the grip portion 222, the protrusion 2221a comes into contact with the periphery of the opening 2211a. This helps prevent disconnection of the grip portion 222 from the holding portion 221 in the removal direction Y1 when the paper powder collection member 20 is removed from the image forming apparatus 100.

The protrusion 2221a has a distal end part that is bent in the axial direction Y1, and the opening 2211a has an inclined surface 2211b. The inclined surface 2211b slopes in the removal direction Y1 (the direction in which the protrusion 2221a is bent) as the periphery of the opening 2211a extends upward (toward the direction in which the protrusion 2221a is bent). In the present embodiment, the distal end part of the protrusion 2221a has an opposing surface 2221b that faces the inclined surface 2211b in the axial direction and that slopes at the same angle as the inclined surface 2211b.

With this arrangement, in a case where a large force is exerted in a direction of separating the grip portion 222 from the holding portion 221 against the biasing force of the coil spring 223, the opposing surface 2221b of the protrusion 2221a comes into contact with the inclined surface 2211b, and the protrusion 2221a becomes engaged with the periphery of the opening 2211a. Thereby, the grip portion 222 can be more assuredly prevented from disconnection from the holding portion 221 in the removal direction Y1.

The embodiments disclosed herein are merely examples in every aspect, and should not be interpreted as limitation. The scope of the present disclosure is defined not by the above description of the embodiments but by the claims, and should be understood to include all modifications within meaning and scope equivalent to the claims.

For example, although an example has been described above in which the present disclosure is applied to a monochrome printer, it should be understood that the scope of the present disclosure is not limited thereto. It is needless to say that the present disclosure is applicable to various types of image forming apparatuses, such as color printers, monochrome copiers, digital multifunction peripherals, facsimile machines, etc., that include a sheet conveyance roller pair and a paper powder collection member.

Furthermore, although the above descriptions of embodiments have dealt with an example configured to collect paper powder adhered to a registration roller pair, it should be understood that the present disclosure is not limited thereto, but may be configured to collect paper powder adhered to a roller pair other than a registration roller pair.

Moreover, although in the above embodiments the outer tube portion 2211 is provided in the holding portion 221 and the inner tube portion 2221 is provided in the grip portion 222, the inner tube portion 2221 may be provided in the holding portion 221 and the outer tube portion 2211 may be provided in the grip portion 222 instead. In that case, it is preferable that the protrusion 2221a has a distal end part that is bent in the axial direction Y2.

What is claimed is:

1. An image forming apparatus, comprising:
a roller pair that is disposed in a main body of the image forming apparatus and conveys a sheet by nipping the sheet; and
a paper powder collection member that is movable for insertion and removal along an axial direction of the roller pair, and that is disposed in contact with one of rollers constituting the roller pair to thereby collect paper powder adhered to the roller pair,
wherein
the paper powder collection member includes
a contact member that contacts the roller pair to thereby collect the paper powder and
a holding member that holds the contact member,
the holding member includes
a holding portion that extends in the axial direction and holds the contact member and
a grip portion that is disposed on one side of the holding portion in the axial direction,
one of the holding portion and the grip portion includes an outer tube portion that is tubular and extends from an end part thereof in the axial direction toward an other of the holding portion and the grip portion,
the other of the holding portion and the grip portion includes an inner tube portion that is tubular and extends from an end part thereof in the axial direction toward the one of the holding portion and the grip portion to be located within the outer tube portion,
the holding portion is connected to the grip portion, via an elastic member disposed within the inner tube portion, so as to be vibratable in the axial direction,
the outer tube portion includes an opening that penetrates the outer tube portion in a radial direction thereof,
the inner tube portion includes a protrusion that protrudes from an outer surface of the inner tube portion so as to be located within the opening, and
when the holding portion vibrates, the protrusion moves in the axial direction within the opening.

2. The image forming apparatus according to claim 1,
wherein
the protrusion includes a distal end part that is bent in the axial direction, and
the opening includes an inclined surface that slopes in a direction in which the protrusion is bent as a peripheral part of the opening extends outward in a radial direction thereof.

3. The image forming apparatus according to claim 2,
wherein
the distal end part of the protrusion includes an opposing portion that faces the inclined surface in the axial direction and slopes at a same angle as the inclined surface.

4. The image forming apparatus according to claim 1,
wherein
the protrusion includes a plurality of protrusions disposed on an outer circumferential surface of the inner tube portion in a circumferential direction of the inner tube, and
the opening includes a plurality of openings disposed corresponding to the plurality of protrusions.

5. The image forming apparatus according to claim 1,
wherein
the roller pair is a registration roller pair that corrects skew of the sheet and conveys the sheet to an image forming portion in coordination with timing of image formation.
